(19) United States
(12) Patent Application Publication
(10) Pub. No.: US 2018/0332213 A1
(43) Pub. Date: Nov. 15, 2018

(54) METHODS AND APPARATUS FOR CONTINUING A ZOOM OF A STATIONARY CAMERA UTILIZING A DRONE

(71) Applicant: MOTOROLA SOLUTIONS, INC, CHICAGO, IL (US)

(72) Inventors: WOJCIECH JAN KUCHARSKI, RZESZOW (PL); IWAN BUGAJSKI, MALOPOLSKA (PL); PAWEL FAFARA, KRAKOW (PL); ANDRZEJ GRZESIK, JAWORZNO (PL); PAWEL JURZEK, KRAKOW (PL); GRZEGORZ KAPLITA, Rzeszów (PL); JAKUB TROJANEK, KRAKOW (PL)

(21) Appl. No.: 15/777,225

(22) PCT Filed: Mar. 24, 2016
(86) PCT No.: PCT/PL2016/050009

§ 371 Date: May 18, 2018

(51) Int. Cl. H04N 5/232; B64C 39/02; G05D 1/00; H04N 7/18

(52) U.S. Cl. CPC H04N 5/23206; B64C 39/024; G05D 1/0011; G05D 1/0094; B64C 2201/146; H04N 5/23299; H04N 7/185; B64C 2201/024; B64C 2201/127; H04N 5/23296

(57) ABSTRACT

A method and apparatus for a video-camera equipped UAV to continue a zoom of the stationary video camera is provided herein. More particularly, a camera mounted on an unmanned aerial vehicle (UAV) is used to extend a field of view (FOV) of a fixed camera in a way that it is seamless for a user who is looking at the video stream and utilizes a joystick to manipulate the camera settings.

### FIELD OF THE DISCLOSURE

The present disclosure relates generally to methods and apparatus for remotely controlling a stationary video camera and a video-camera equipped UAV in order to continue a zoom of the stationary video camera.

### BACKGROUND

Remotely-controlled video camera systems currently are in use, in which a video camera positioned within a particular area captures and transmits images of the area to a remote viewer terminal over a data path. The received images (i.e., video) may then be displayed to a human operator (or viewer) at the remote viewer terminal.

Some systems include pan-tilt-zoom (PTZ) types of cameras, which are controllable to produce images associated with different fields of vision, where the “field of vision” (or FOV) associated with an image is the extent of the observable world that is conveyed in the image. In such systems, the operator of the remote viewer terminal may remotely control the FOV associated with the images provided by the camera by actuating various PTZ control components (e.g., joysticks) associated with the remote viewer terminal. For example, a remote video camera may be producing images associated with a fixed FOV, and the operator may manipulate a joystick to cause the camera to pan to a different FOV and/or to change the FOV by zooming in or out. Alternatively, if the camera already is zooming, the operator may manipulate the joystick to indicate that the operator wants the camera to stop zooming or continue zooming, and to provide images associated with a desired FOV.

Oftentimes an operator may wish to zoom a camera beyond its capabilities. For example, in order to read a license plate on a far-away automobile, a minimum zoom of 50× may be needed, however the camera may only be capable of zooming 20×. Alternatively, consider a scenario when an operator may wish to see a bigger region/picture (e.g. from higher altitude) but a camera has reach the zoom out limit. Therefore, there is a need for a method and apparatus for continuing a zoom of a camera.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a simplified block diagram of a system that includes a remote viewer terminal configured to communicate with a camera over a data path, in accordance with some embodiments.

FIG. 2 is a more-detailed block diagram of a system that includes a remote viewer terminal configured to communicate with a camera over a data path, in accordance with some embodiments.

FIG. 3 is a block diagram of a UAV as shown in FIG. 1 and FIG. 2.

FIG. 4 is a flow chart showing operation of the system of FIG. 1 in accordance with a first embodiment.

FIG. 5 is a flow chart showing operation of the system of FIG. 1 in accordance with a second embodiment.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

In order to address the above-mention need, a method and apparatus for a video-camera equipped UAV to continue a zoom of the stationary video camera is provided herein. More particularly, a camera mounted on an unmanned aerial vehicle (UAV) is used to extend a field of view (FOV) of a fixed camera in a way that it is seamless for a user who is looking at the video stream and utilizes a joystick to manipulate the camera settings.

When the camera's zoom or pan range is close to a maximum (or minimum), the received control signals (received from, for example, a user's joystick movements) will be passed to the UAV along with a FOV. The UAV positions itself along the camera's axis to match its FOV with the camera's FOV. The control signals switch from manipulating PTZ camera's settings to indirectly guiding UAV's movement.

The above steps gives a camera a perceived enhanced resolution and mobility, which can even zoom in ‘through’ obstacles or zoom out to a bird's eye view. In addition, a camera mounted to a single UAV can be used with many fixed PTZ cameras.

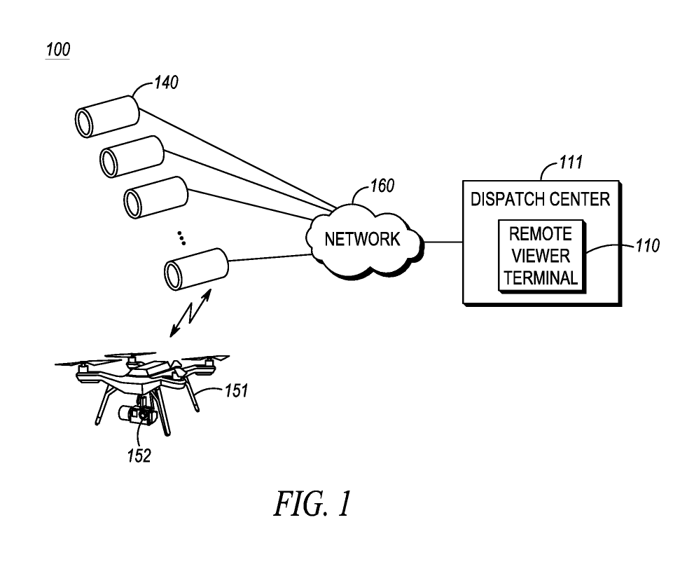

FIG. 1 is a block diagram showing a general operational environment 100, according to one embodiment of the present invention. In this particular illustration the camera-control functionality of a remote viewer terminal 110 is placed within a control center, (e.g., a police-dispatch center as part of a public-safety agency) 111. As shown in FIG. 1 a plurality of imaging systems 140 are in communication with dispatch center 111 through intervening network 160. Network 160 may comprise one of any number of over-the-air or wired networks. For example network 160 may comprise a private 802.11 network set up by a building operator, a next-generation cellular communications network operated by a cellular service provider, or any public-safety network such as an APCO 25 network or the FirstNet broadband network.

In this particular embodiment, imaging systems 140 provide video images to terminal 110 within dispatch center 111 through intervening network 160. More particularly, imaging systems 140 electronically capture a sequence of video frames (i.e., a sequence of one or more still images), with optional accompanying audio, in a digital format. These video frames are sent from camera 103 to remote viewer terminal 110 through network 160. Along with video frames, a camera ID and/or camera location is also provided to remote viewer terminal 110.

As shown in FIG. 1, UAV 151 is provided comprising camera 152. As discussed above when any imaging system 140 reaches a maximum pan or zoom, UAV 151 will be notified. Any request by a user to increase the zoom beyond the camera's limits, or any request by a user to pan beyond the camera's limits will be conveyed to UAV 151. Other information will be provided to UAV 151 so that UAV will position itself to capture images/video along a line-of-sight of the camera. Instructions sent to the camera will be translated to position and zoom instructions for UAV 151. Video/images received by imaging system 140 from UAV 151 (specifically, camera 152) will be provided to remote viewer terminal 110 through network 160.

All cameras are controllable to change a FOV, with respect to a fixed coordinate system, of images transmitted by the camera to a remote viewer terminal 110 located within a control center or dispatch center 111. As used herein, the term “field of vision” or “FOV” means the extent of the observable world that is encompassed by an image that is transmitted by the camera to the remote viewer terminal. Transmitted images alternatively may be referred to herein as being “produced” or “provided” by the camera and/or the UAV.

According to an embodiment, all cameras are a PTZ-type of camera, which is remotely-controllable to produce images with different FOVs. As used herein, the term “pan” means to change the FOVs of images that are sequentially produced by the camera. The term “pan” is intended to indicate any type of change in the FOVs of sequentially produced images, including FOV changes associated with rotational camera movement about any axis (e.g., panning about one axis and/or tilting about another axis) and FOV changes associated with changes in magnification level (e.g., zooming in or out). For camera 152, the FOV changes may be accomplished by physically moving drone 151 or by panning, tilting, or zooming camera 152.

Although the term “PTZ” may be used herein in describing example camera embodiments, it is to be understood that embodiments may be incorporated in systems that include cameras capable of changing FOVs about multiple axes, cameras capable of changing FOVs only about a single axis, cameras capable of changing a FOV by physically moving the camera, cameras with multiple zoom capabilities, and cameras without zoom capabilities. In addition, embodiments may be incorporated in systems in which a drive system is controllable to physically move and zoom the camera through a multitude of camera orientations, while capturing images, in order to pan across an observable environment.

Other embodiments may be incorporated in systems in which the camera captures wide-angle images (e.g., panoramic images, anamorphic images, 360 degree images, distorted hemispherical images, and so on) and selects sequences of overlapping but offset pixel sub-sets in order to virtually pan across the environment encompassed by the wide-angle images. The term “pan,” as used herein, includes both physically moving a camera through multiple camera orientations, and virtually panning a camera by sequentially selecting offset pixel sub-sets within captured, wide-angle images.

An operator of an embodiment of a remote viewer terminal 110 (located in dispatch center 111) may remotely control the FOVs associated with the images produced by a camera by actuating various control components (e.g., joystick controls and/or other user interface components) associated with the remote viewer terminal. For example, the operator may manipulate a joystick to cause a camera to pan across a scene that is observable by the camera. In addition, the operator may manipulate various control components to cause the camera to zoom in toward or out from a scene. While the camera is panning, the operator may see an image displayed on the remote viewer terminal, which corresponds to a desired FOV (i.e., an FOV at which the operator would like the camera to capture additional images) or which includes an object that the operator may want the camera to maintain within the provided images (e.g., thus defining a desired FOV).

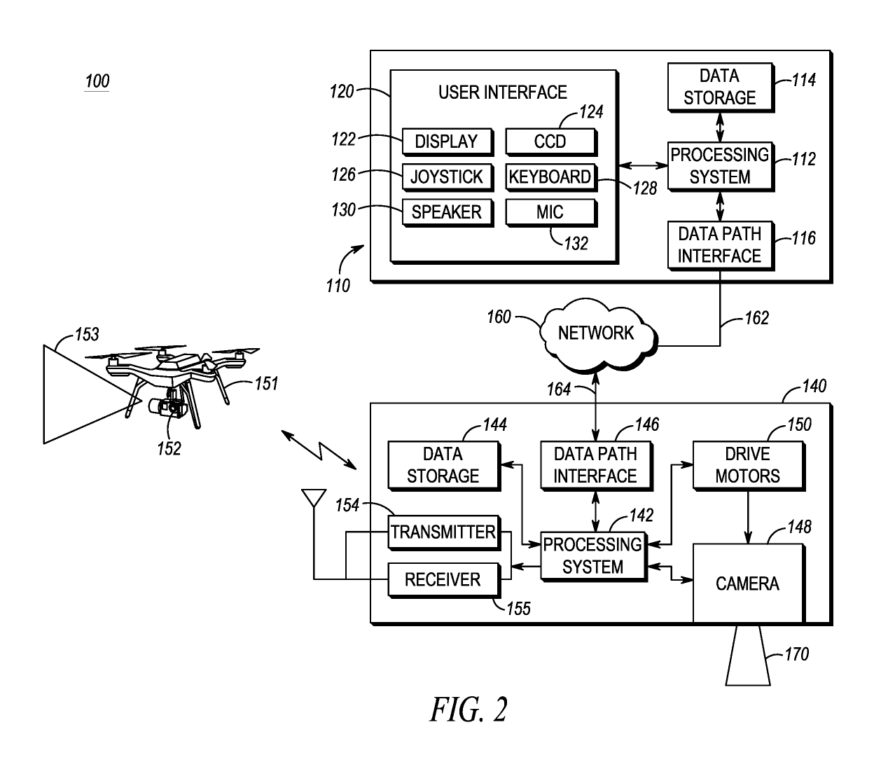

FIG. 2 is a more-detailed block diagram of a environment 100 that includes a remote viewer terminal 110 configured to communicate with an image capture device 140 (also referred to as a “camera” or “remotely-controlled camera,” herein) over a data path, in accordance with some embodiments.

The data path may include a single data communications network or multiple, interconnected data communications networks through which the remote viewer terminal 110 and the image capture device 140 communicate. For example, the data path may include various wired and/or wireless networks and corresponding interfaces, including but not limited to the Internet, one or more wide area networks (WANs), one or more local area networks (LANs), one or more Wi-Fi networks, one or more cellular networks, and any of a number of other types of networks. According to an embodiment, a network 160 is present along the data path, thus defining a first portion 162 of the data path between the remote viewer terminal 110 and the network 160, and a second portion 164 of the data path between the image capture device 140 and the network 160.

According to an embodiment, remote viewer terminal 110 and/or image capture device 140 are configured to communicate wirelessly with their respective portions 162, 164 of data path, and accordingly, at least one component of the data path provides a wireless communication interface to image capture device 140 and/or remote viewer terminal 110. In alternate embodiments, either or both remote viewer terminal 110 and/or image capture device 140 may communicate over a hardwired communication link with their respective portions 162, 164 of the data path. In yet another alternate embodiment, remote viewer terminal 110 and image capture device 140 may be directly connected together, in which case the data path may not specifically include a data communications network (or a network 160). Either way, the data path provides a communication interface between remote viewer terminal 110 and image capture device 140. In a particular embodiment, the data path supports the communication of single images and a stream of images, herein referred to as “video,” from image capture device 140 to remote viewer terminal 110, and the communication of various other types of information and commands between the remote viewer terminal 110 and the image capture device 140.

Remote viewer terminal 110 may be, for example, an operator terminal associated with dispatch center 111 or a Public Safety Answer Point (PSAP), although the remote viewer terminal could be a computer or terminal associated with a different type of system or a computer or terminal having no association with any particular system at all. Either way, a human “remote viewer” (not illustrated) interacts with remote viewer terminal 110 in various ways, which will be described in more detail below.

Remote viewer terminal 110 includes a processing system 112, data storage 114, data path interface 116, and user interface 120, in an embodiment. Data path interface 116 enables the remote viewer terminal 110 to communicate over the data path with the image capture device 140 and/or the network 160. Data path interface 116 includes apparatus configured to interface with whatever type of data path is implemented in the system shown in FIG. 1 (e.g., data path interface 116 may facilitate wired or wireless communication with a network of the data path, or may facilitate communication with image capture device 140 over a direct connection).

Processing system 112 may include one or more general-purpose or special-purpose processors, which are configured to execute machine readable software instructions that are stored in data storage 114. The machine readable software instructions may correspond to software programs associated with implementing various example embodiments. The software programs include programs that interpret user inputs to various input devices of user interface 120, cause a display 122 to display various images and other information, interface with data storage 114 to store and retrieve data, coordinate the establishment and maintenance of voice and data communication paths with image capture device 140 over the data path, process data (e.g., images, image identifiers, and so on) received over the data path from image capture device 140, and generate commands (e.g., pan commands, zoom commands, and so on) to be transmitted over the data path to image capture device 140 and/or network 160.

Data storage 114 may include random access memory (RAM), read only memory (ROM), compact disks, hard disks, and/or other data storage devices. Data storage 114 is configured to store data representing captured images, which have been received from image capture device 140. In addition, data storage 114 is configured to store image identifiers and/or FOV references received from network 160 and/or from image capture device 140 in conjunction with the image data.

User interface 120 may include one or more of each of the following types of input and output devices: display 122, cursor control device (CCD) 124, joystick 126, keyboard 128, speaker 130, and microphone (MIC) 132. The various input devices (e.g., display 122 (when it is a touch screen), CCD 124, joystick 126, keyboard 128, and microphone 132) enable the remote viewer to send various FOV control commands to the image capture device 140. As used herein, an “FOV control command” is a command to the image capture device 140 which, when followed by the image capture device 140, affects the FOVs of images produced by the image capture device 140. For example, the input devices could be used to initiate FOV control commands such as pan-related commands (e.g., pan left, pan right, pan up, pan down, stop panning, and so on) and magnification adjustment commands (e.g., increase magnification (zoom in), decrease magnification (zoom out), and so on).

Under the control of processing system 112 (or a display controller associated therewith), display 122 is configured to display images (e.g., still images and video) conveyed in image data from image capture device 140. In addition, display 122 may be utilized to display various other types of information (e.g., textual information, select lists, selectable icons, and so on). Display 122 may be a touch screen or non-touch screen type of display. In the former case, display 122 is considered both an input and an output device, and the remote viewer may select various displayed images and/or objects by touching corresponding portions of the touch screen. In the latter case, display 122 is considered an output-only device.

CCD 124 may include any one or more devices that enable the remote viewer to select a displayed image or object, such as a mouse, touchpad, button, and so on. In addition, in an embodiment in which display 122 is a touch screen type of display, those aspects of display 122 that provide the touch screen capabilities may be considered to be portions of CCD 124. CCD 124 enables the remote viewer to select an image and/or an object within an image, where that selection may be used to determine a desired FOV for images provided by the image capture device 140. Consistent with the image or object selections specified via CCD 124, display 122 or some other input device, processing system 112 generates and transmits FOV control commands to the image capture device 140. Upon receiving such FOV control commands, the image capture device 140 provides (e.g., transmits to remote viewer terminal 110) images having FOVs that are consistent with the FOV control commands.

Joystick 126 may include one or multiple sticks, which pivot on a base, and a processing component that interprets and reports stick angle and/or stick direction information to processing system 112. Joystick 126 also may include one or more additional buttons or controls, which enable the remote viewer to change the joystick mode of operation, indicate a selection, and/or indicate a desired change in an optical magnification level of the image capture device 140. For example, as will be described in more detail later, a remote viewer may want the image capture device 140 to pan in a particular direction, so that the camera 148 of the device 140 may capture images in a different FOV from its current FOV (e.g., FOV 170). Alternatively, a remote viewer may want the image capture device 140 to stop panning. In addition, a remote viewer may want the image capture device 140 to cause its camera 148 to increase or decrease an optical magnification level in order to zoom in or zoom out, respectively, while the image capture device 140 is capturing images. These desired changes may be indicated through manipulations of joystick 126, in an embodiment, or through manipulations of other components of user interface 120, in other embodiments.

According to an embodiment, when the image capture device 140 is configured to physically change an orientation of camera 148 with respect to a fixed coordinate system in order to pan, joystick 126 may enable the remote viewer to indicate that the remote viewer wants the image capture device 140 to change the orientation of the camera 148 (e.g., pan left, pan right, pan up, pan down), to stop panning (e.g., when the operator releases the first stick), or to change the optical magnification level. Conversely, when the image capture device 140 captures wide-angle images and virtually pans by selecting portions of the wide angle images (rather than changing the physical orientation of the camera 148), joystick 126 may enable the remote viewer to indicate that the remote viewer wants the image capture device 140 to select portions of the wide-angle images captured by camera 148 in a manner that simulates panning (e.g., pan left, pan right, pan up, pan down), to stop simulated panning (e.g., when the operator releases the joystick), or to change the optical magnification level.

In alternate embodiments, panning and magnification change requests may be stipulated by the remote viewer by manipulating keys on keyboard 128 (e.g., arrow keys), selecting (via CCD 124) orientation and/or directional indicators displayed on display 122, or typing (via keyboard 128) various commands. Either way, processing system 112 generates and transmits FOV control commands to the image capture device 140, which are consistent with the inputs to joystick 126 (e.g., the stick angle and/or stick direction information produced by joystick 126) or other user interface components. As will also be described in detail later, upon receiving such FOV commands, the image capture device 140 provides (e.g., transmits to remote viewer terminal 110) images having FOVs that are consistent with the FOV control commands. When an FOV control command corresponds to an optical magnification level change, the image capture device 140 automatically (i.e., without interaction with the device operator) may adjust the optical magnification level according to the command.

Keyboard 128 may be a standard QWERTY keyboard, or a specialized keyboard that is configured to enable a remote viewer to input information via various keys. For example, via keyboard 128, a remote viewer may provide textual FOV related instructions, and/or information that may be converted into FOV control commands (e.g., geographical coordinates, and so on). In addition, the remote viewer may be able to indicate selection of an image or object via keyboard 128.

Although FIG. 2 illustrates the remote viewer terminal 110 as a stand-alone device that communicates with the image capture device 140 via a data path, it is to be understood that the remote viewer terminal 110 may form a portion of a larger system (e.g., a PSAP system). Such a system may include multiple remote viewer terminals, routing equipment, data and communication server(s), and so on. In addition, although FIG. 2 depicts processing system 112 and data storage 114 as being incorporated in remote viewer terminal 110, it is to be understood that some functions associated with the various embodiments could be performed outside the remote viewer terminal 110 (e.g., by network 160). In addition, some software programs and/or data may be stored in data storage devices that are distinct from the remote viewer terminal 110.

Image capture device 140 may be any one of various types of devices, including but not limited to a panning camera, a pan/tilt (PT) camera, a PTZ camera, a panoramic camera (e.g., a 360 degree camera), a fisheye camera, and a box camera. Image capture device 140 includes a processing system (logic circuitry) 142, data storage 144, data path interface 146, and camera 148, in an embodiment. In embodiments in which image capture device 140 is configured to physically change the orientation of camera 148 in order to change the FOV of images produced by image capture device 140, image capture device may also include one or more drive motors 150.

Data path interface 146 enables the image capture device 140 to communicate over the data path with the remote viewer terminal 110 and/or network 160. Data path interface 146 includes apparatus configured to interface with whatever type of data path is implemented in the system shown in FIG. 1 (e.g., data path interface 146 may facilitate wired or wireless communication with a network of the data path, or may facilitate communication with remote viewer terminal 110 over a direct connection).

Processing system 142 may include one or more general-purpose or special-purpose processors, which are configured to execute machine readable software instructions that are stored in data storage 144. The machine readable software instructions may correspond to software programs associated with implementing various example embodiments. As will be discussed in more detail below, the software programs include programs that cause camera 148 to capture images, determine and store camera orientation information (e.g., drive motor settings associated with captured images), interface with data storage 144 to store and retrieve data (e.g., image data, image identifiers, and/or FOV definitions), coordinate the establishment and maintenance of data communication paths with remote viewer terminal 110 and/or network 160 over the data path, process information (e.g., FOV control commands, and so on) received over the data path from remote viewer terminal 110 and/or network 160, coordinate processing and transmission of image data and image identifiers (or FOV definitions) over the data path to remote viewer terminal 110 and/or the network 160, translate FOV control commands to drone movements, and relay drone video to terminal 110.

Data storage 144 may include RAM, ROM, compact disks, hard disks, and/or other data storage devices. Data storage 144 is configured to store software instructions (as mentioned above) and additional data associated with the performance of the various embodiments. For example, data storage 144 is configured to store data representing images that have been captured by camera 148, image identifiers, and FOV definitions.

Cameras 148 and 152 are digital camera configured to capture images within FOV 170, 153 and to convert those images into image data. Under control of processing system 142, cameras 148 and 152 may be controlled to capture still images and/or to capture video (e.g., continuous streams of still images), and to convert the captured images into image data. In an embodiment, cameras 148 and 152 and/or processing system 142 compresses the image data prior to storing the image data in data storage 144, although the image data may be stored in an un-compressed format, as well. “Image data,” as used herein, refers to data, in compressed or un-compressed formats, that defines one or more captured images. The image data may be sent to user interface 120 in any format.

According to an embodiment, cameras 148 and 152 also include zoom capabilities (i.e., variable optical magnification of the FOV 170, 153), which may be remotely controlled via commands received from remote viewer terminal 110. The term “optical magnification” is used herein to denote any adjustment to the magnification of the captured FOV or the FOV of an image produced by the image capture device 140 or UAV 151, whether instrumented through manipulation of the lens, and/or through subsequent digital processing of a captured images (e.g., through digital zoom, which selects subsets of pixels from a captured image).

The FOV 170 and 153 of cameras 148 and 152 are determined by terminal 110 providing FOV control commands to processing system 142, which provides commands to drive motors 150 and UAV 151, which cause the actual physical orientation of camera 148, camera 152, and position of UAV 151 to change with respect to a fixed coordinate system (e.g., by rotating or zooming cameras 148 and 152 and/or by physically moving UAV 151).

Finally, transmitter 154 is provided to transmit translated FOV control commands to drone 151, and receiver 155 is provided to receive images from drone 151. Transmitter 154 and receiver 155 are well known long-range and/or short-range transceivers that utilize, for example a private 802.11 network and system protocol.

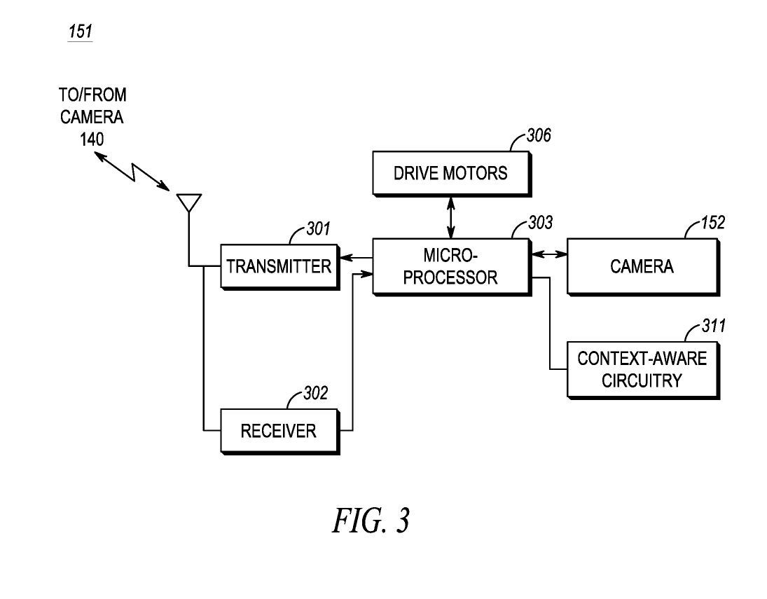

FIG. 3 is a block diagram of a UAV as shown in FIG. 1 and FIG. 2. As shown, UAV 151 may include transmitter 301, receiver 302, logic circuitry 303, camera 152, memory 304, and context-aware circuitry 311. Transmitter 301 and receiver 302 may be well known long-range and/or short-range transceivers that utilize, for example, a private 802.11 network Transmitter 301 and receiver 302 may also contain multiple transmitters and receivers, to support multiple communications protocols simultaneously. Drive motors 306 preferably comprise standard UAV motors coupled to propellers (not shown) that together form a propulsion system for UAV 151. Logic circuitry 303 comprises a digital signal processor (DSP), general purpose microprocessor, a programmable logic device, or application specific integrated circuit (ASIC) and is utilized to receive messages from an imaging system 140 and move accordingly. Logic circuitry 303 also receives images from camera 152 and relays them to system 140 through transmitter 301.

Context-aware circuitry 311 may comprise any device capable of generating an estimated FOV for camera 152. For example, context-aware circuitry 311 may comprise a combination of a GPS receiver capable of determining a geographic location, a level sensor, a gyroscope, and a compass. A camera FOV may comprise a camera's location and/or its pointing direction, for example, a GPS location, a level, and a compass heading. Based on the geographic location, level, and compass heading, a FOV of camera 152 can be determined by microprocessor 303. For example, a current location of camera 152 may be determined (e.g., 42 deg 04′ 03.482343″ lat., 88 deg 03′ 10.443453″ long. 727 feet above sea level), and a compass bearing matching the camera's pointing direction may be determined (e.g., 270 deg. from North), a level direction of the camera may be determined from the image (e.g., −25 deg. from level). From the above information, the camera's FOV is determined by determining a geographic area captured by the camera.

As discussed above, oftentimes an operator utilizing interface 120 may wish to utilize camera 148 beyond its capabilities (e.g., zoom in or out). For example, in order to read a license plate on a far-away automobile, a minimum zoom of 50× may be needed, however the camera may only be capable of zooming 20×. When processing system 142 determines that drive motors or a zoom level has reached a limit, processing system 142 may determine a current FOV for camera 148, and transmit the current FOV to drone 151 via transmitter 154.

At drone 151, receiver 302 will receive the FOV of camera 148 and pass this to logic circuitry 303. Logic circuitry 303 accesses context-aware circuitry 311 to determine a current FOV of camera 152. Logic circuitry 303 then determine necessary adjustments to its position to match the FOVs for camera 148 and camera 152. When the FOVs are matched, logic circuitry forwards images from camera 152 to system 140 via transmitter 301.

As FOV control commands are received by processing system 142, the FOV control commands are translated to a desired camera FOV, and transmitted to drone 151. Drone 151 then makes the necessary positional adjustments to match the FOV of camera 152 to the desired camera FOV.

### Determining a FOV for Camera 148

Since system 140 is stationary, processing system 142 will know its current location (which may be stored in storage 144). The camera FOV may comprise a camera's location and its pointing direction (as determined from drive motors 150), for example, a GPS location, a level, and a compass heading. Based on the geographic location, level, and compass heading, a FOV of camera 148 can be determined by processor 142. For example, a current location of camera 148 may be determined (e.g., 42 deg 04′ 03.482343″ lat., 88 deg 03′ 10.443453″ long. 727 feet above sea level), and a compass bearing matching the camera's pointing direction may be determined (e.g., 270 deg. from North), a level direction of the camera may be determined from the image (e.g., −25 deg. from level), and a zoom level may be determined (e.g., 10×). From the above information, the camera's FOV is determined by determining a geographic area captured by camera 148.

### Determining a FOV for Camera 152

Since camera 152 is not fixed at any given position, logic circuitry 303 will access context-aware circuitry to determine a current location. The camera FOV may comprise a camera's location and its pointing direction (as determined from drive context-aware circuitry 311), for example, a GPS location, a level, and a compass heading. Based on the geographic location, level, and compass heading, a FOV of camera 152 can be determined by logic circuitry 303. For example, a current location of camera 152 may be determined (e.g., 42 deg 04′ 03.482543″ lat., 88 deg 03′ 10.443453″ long. 727 feet above sea level), and a compass bearing matching the camera's pointing direction may be determined (e.g., 270 deg. from North), a level direction of the camera may be determined from the image (e.g., −25 deg. from level), and a zoom level may be determined (e.g., 1×). From the above information, the camera's FOV is determined by determining a geographic area captured by camera 152.

### Positioning Camera 152 Based on FOV Control Commands

During operation processing system 142 will determine a FOV for camera 148 as discussed above. As FOV control commands are received, processing system 142 will adjust drive motors 150 (which also controls a zoom motor) accordingly. When a limit is reached on any drive motor (e.g., a pan limit, or a zoom limit), processing system notifies drone 151. As part of the notification, a current FOV for camera 148 is transmitted to drone 151.

As processing system 142 continues to receive FOV control commands from user interface 120, processing system 142 will translate these commands into a desired FOV for camera 148, even though camera 148 is incapable of providing such a FOV. The desired FOV will be transmitted to UAV 151, which will adjust its position and provide the requested FOV.

### Adjusting UAV Position Based on FOV

During operation of the system shown in FIG. 1, logic circuitry 303 will receive a FOV via receiver 302. Logic circuitry 303 will use the provided FOV to operate drive motors 306 accordingly in order to position camera 152 to capture the desired FOV. More specifically, an “increase zoom” command may be translated into an increased distance from a fixed point (i.e., a fixed camera), a horizontal rotation may be translated into UAV horizontal rotation around a fixed camera and UAV horizontal movement will be proportional to a zoom level, and a vertical rotation may be translated into UAV vertical rotation around a fixed camera and UAV elevation will be proportional to a zoom level.

Note that to keep seamless switching from the fixed camera to the UAV and back, the fixed camera may continue to track the UAV during the time when UAV takes over, so UAV is always in the center of camera's (temporarily not used) FOV.

Once properly positioned, logic circuitry 303 will then direct transmitter 301 to provide a feed of camera 152 receiver 155. The camera feed will be relayed to user interface 120 for display on display 122. Thus, receiver 155 will receive a video feed from camera 152, causing microprocessor 142 to forward it to display 122 instead of the camera feed from camera 148. If the user again places camera 148 within its designed parameters, then processing system 142 will determine so, and again provide the camera feed from camera 148.

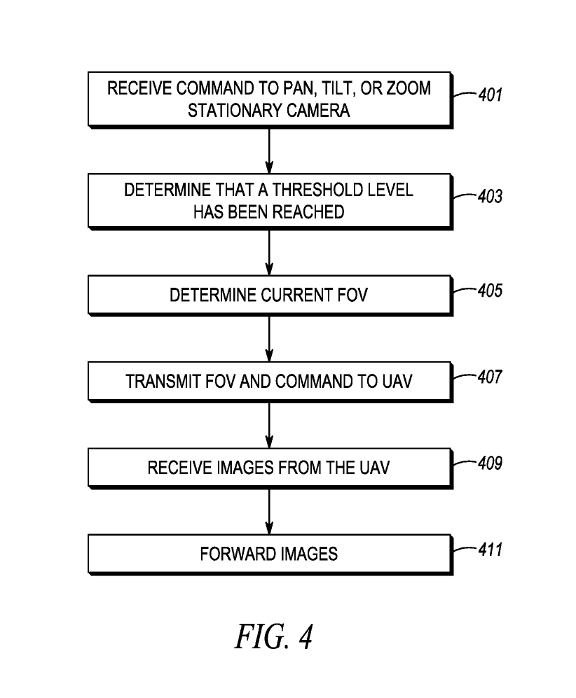

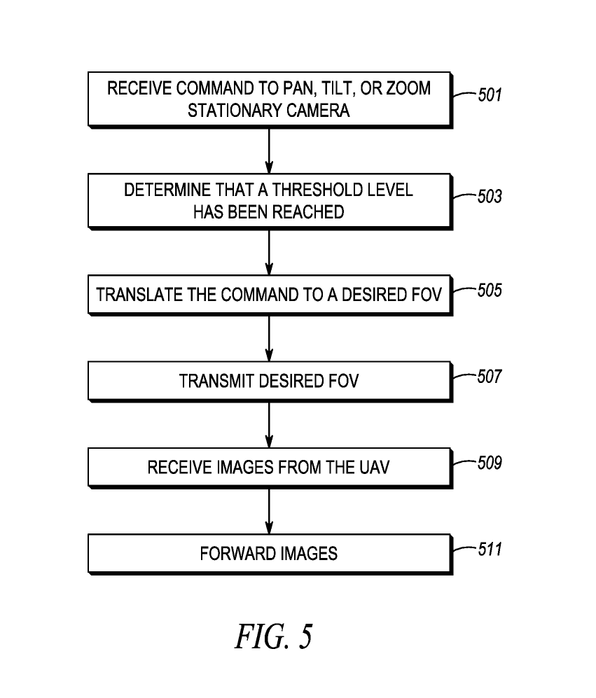

It should be noted that while the above text described received control commands being “translated” into a FOV, and the FOV being provided to drone 151, in an alternate embodiment of the present invention, the control command may be provided directly to drone 151, and drone 151 may maneuver accordingly. In this scenario, an original FOV may be provided to drone 151 so that drone 151 may align its FOV with the FOV of camera 148. Once drone 151 has aligned accordingly, processing system 142 may then simply forward control commands as it receives them from user interface 120. Both embodiments are described below in FIG. 4, and FIG. 5.

FIG. 4 is a flow chart showing operation of the system of FIG. 1 in accordance with a first embodiment. In particular, the steps shown in FIG. 4 comprise those (all of which are not necessary) that position UAV 151 by sending control commands. The logic flow begins at step 401 where processing system 142 receives a control command from a user terminal 120 to pan, tilt, or zoom a stationary camera 148 (the term stationary in this context is meant to convey the fact that camera 148 is immobile, only capable of panning, tilting, and/or zooming from a stationary location).

At step 403 logic circuitry 142 determines that threshold zoom level has been reached by the stationary camera. As discussed above, the threshold level may be some level approaching a maximum limit of a parameter for camera 148 (e.g., 90% zoomed in, or 90% zoomed out). In response logic circuitry 142 determines a current FOV (step 405) and transmits instructions to the UAV to position the UAV to capture the current FOV. This may entail simply transmitting the FOV to the UAV. Along with the instructions to position the UAV, the received control command is also transmitted to the UAV(step 407). At step 409, logic circuitry 142 receives images/video from the UAV after the UAV has positioned or moved as indicated by the received command. Finally, optional step 411 is executed, where logic circuitry 142 forwards (transmits) the images/video received from the UAV to the user terminal.

As discussed above, the step of receiving images/video from the UAV may comprise the step of receiving the images/video over a wireless link. While the command to pan, tilt, or zoom the stationary camera is additionally received via an over-the-air signal.

FIG. 5 is a flow chart showing operation of the system of FIG. 1 in accordance with a second embodiment. In this particular embodiment, processing system 142 translates, or converts all received control commands into desired FOVs, and the desired FOVs are transmitted to drone 151 to act accordingly. The logic flow begins at step 501 where logic circuitry 142 receives a control command from a user terminal to pan, tilt, or zoom a stationary camera. At step 503 logic circuitry 142 determines that a threshold zoom level has been reached by the stationary camera, and translates the control command to a desired FOV (step 505). The desired FOV is transmitted to a UAV (step 507) and in response, images/video is received from the UAV after the UAV has positioned or moved as indicated by the desired FOV (step 509). Optionally, at step 511 the images/video may be transmitted to user interface 120

In the foregoing specification, specific embodiments have been described. However, one of ordinary skill in the art appreciates that various modifications and changes can be made without departing from the scope of the invention as set forth in the claims below. For example, while a UAV was utilized to seamlessly zoom a camera after a limit has been reached, in other embodiments of the present invention the UAV may be utilized as described above when other limits (resolution, bitrate, compression level, compression algorithm, . . . , etc.) are reached. Accordingly, the specification and figures are to be regarded in an illustrative rather than a restrictive sense, and all such modifications are intended to be included within the scope of present teachings.

Those skilled in the art will further recognize that references to specific implementation embodiments such as “circuitry” may equally be accomplished via either on general purpose computing apparatus (e.g., CPU) or specialized processing apparatus (e.g., DSP) executing software instructions stored in non-transitory computer-readable memory. It will also be understood that the terms and expressions used herein have the ordinary technical meaning as is accorded to such terms and expressions by persons skilled in the technical field as set forth above except where different specific meanings have otherwise been set forth herein.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method for controlling an unmanned, aerial vehicle (UAV), the method comprising the steps of:
receiving a control command from a user terminal to pan, tilt, or zoom a stationary camera;
determining that a threshold zoom level has been achieved by the stationary camera;
determining a current FOV;
transmitting instructions to position the UAV to capture the current FOV;
transmitting the received control command; and
receiving images/video from the UAV after the UAV has positioned or moved as indicated by the received control command.

2. The method of claim 1 further comprising the step of:
transmitting the images/video received from the UAV to the user terminal.

3. The method of claim 1 wherein the step of receiving images/video from the UAV comprises the step of receiving the images/video over a wireless link.

4. The method of claim 1 wherein the control command to pan, tilt, or zoom the stationary camera is received via an over-the-air signal.

5. The method of claim 1 wherein the user terminal is part of a public-safety agency.

6. A method for controlling an unmanned, aerial vehicle (UAV), the method comprising the steps of:
receiving a control command from a user terminal to pan, tilt, or zoom a stationary camera;
determining that a threshold zoom level has been achieved by the stationary camera;
translating the control command to a desired FOV;
transmitting the desired FOV to the UAV; and
receiving images/video from the UAV after the UAV has positioned or moved as indicated by the desired FOV.

7. The method of claim 6 further comprising the step of:
transmitting the images/video received from the UAV to the user terminal.

8. The method of claim 6 wherein the step of receiving images/video from the UAV comprises the step of receiving the images/video over a wireless link.

9. The method of claim 6 wherein the control command to pan, tilt, or zoom the stationary camera is received via an over-the-air signal.

10. The method of claim 6 wherein the user terminal is part of a public-safety agency.

11. An apparatus comprising:
a receiver receiving a control command from a user terminal to pan, tilt, or zoom a stationary camera;
logic circuitry determining that a threshold zoom level has been achieved by the stationary camera, and determining a current FOV;
a transmitter transmitting instructions to position a UAV to capture the current FOV and transmitting the received control command; and
the receiver receiving images/video from the UAV after the UAV has positioned or moved as indicated by the received control command.

12. The apparatus of claim 11 wherein the images/video received from the UAV are forwarded to the user terminal.

13. The apparatus of claim 11 wherein the images/video are received over a wireless link.

14. The apparatus of claim 11 wherein the control command to pan, tilt, or zoom the stationary camera is received via an over-the-air signal.

15. The apparatus of claim 11 wherein the user terminal is part of a public-safety agency.
